(19) United States
(12) Patent Application Publication
(10) Pub. No.: US 2014/0101161 A1
(43) Pub. Date: Apr. 10, 2014

(54) Method and system to manage privacy of shared contact information.

(71) Applicant: Manah Khalil, Irving, TX (US)

(72) Inventor: Manah Khalil, Irving, TX (US)

(21) Appl. No.: 13/648,235

(22) Filed: Oct. 9, 2012

(51) Int. Cl. G06F 17/30

(52) U.S. Cl. CPC G06F 17/30598
USPC 707/738

(57) ABSTRACT

A method for determining an address include the steps of registering an alias and associating it with one or more sets of contact information, providing an alias to obtain the address or other contact information, determining if the alias has been registered, resolving the alias to obtain the address.

### Priority

The present invention claims priority under 35 USC section 119 based upon a provisional application which was filed on Oct. 10, 2011 with a Ser. No. 61/545,522

### FIELD OF THE INVENTION

The present invention relates to a system and method for sharing contact information such as mailing address and more particularly to a system and method for managing the privacy of said contact information.

### BACKGROUND

Delivery of mail to a physical address or PO Box can at times be problematic especially when people change residences. Several parties who have a relationship with these parties will be impacted by the change of address, costing significant time, effort and money to the US Postal Service (USPS), businesses and people. Some other people may not like their existing mailing addresses, but still have to use it for correspondence. In addition, keeping the residence address and other contact information such as an email address private is generally challenging taking into consideration the fact that the service providers and businesses require using the that information to furnish a service.

Another problem may be the amount of effort and cost that businesses and individuals incur during the time period of the change of address. The cost impacts the people who are moving, potentially causing loss of service till the address change takes effect, the business that the people are dealing with, causing them the additional cost to manage the change of address, pay for the cost of returned mail, undelivered billed, and process to support an address move are just a few of these costs. Also the change of address will cost the USPS and other delivery services due to the failed delivery and re-route to the new address.

As discussed above, the problems associated with current mail system include but are not limited to people that do not like their mailing address but still have to use it to guarantee service.

An additional problem includes the lack of privacy and the need to either disclose a physical mailing address, a phone number, or other contact information to a service provider and not have control of how that information is later used or shared on behalf of the owner of that information. The above may not just be limited to the mailing address but also include other form of contact information such phone numbers, email addresses, fax, a web URL, Twitter handle, a personal photograph, or other contact information.

### SUMMARY

A method for determining contact information include the steps of providing an alias to obtain the address, determining if the alias has been registered, resolving the alias to obtain some or all of the contact information.

The step of resolving the alias to obtain the contact information may include the step of accessing a database.

The method may include the step of returning the mailing address or other contact information to the user.

The method may include the step of informing the user that the alias does not exist if the alias has not been registered.

The method may include the step of informing the user that the alias has privacy settings that limit sharing part or all of the contact information.

The method may include the step of determining which contact information set for an alias that is associated with multiple such contact information sets is the intended one.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a diagram of examples of aliases and corresponding physical addresses which may be used by the present invention;

FIG. 2 illustrates a flowchart illustrating the present invention registering aliases;

FIG. 3 illustrates a flowchart diagram showing how the United States Postal Service USPS and other organizations interact with the present invention.

FIG. 4 illustrates a flowchart showing the validation of the alias for the present invention;

FIG. 5 illustrates a flowchart showing the result of the alias query for the present invention;

FIG. 6 illustrates a system diagram for the alias of the present invention.

### DETAILED DESCRIPTION

The following detailed description refers to the accompanying drawings. The same reference numbers in different drawings may identify the same or similar elements. Also, the following detailed description does not limit the invention.

The enclosed invention herein describes a service that will allow users the use of a custom, registered alias instead of their actual mailing, physical address or other contact information, and the present invention eliminates several of the adverse side effects associated with the problems mentioned above. In addition, the invention describes the alias notation and its different formats. The alias is resolved by translating the alias (and perhaps a permission password) to the real physical address by USPS, other delivery services, or other business for the actual use of that contact information for the purpose of delivering mail or furnishing a specific service such as calling a customer or corresponding through email. The service can also be extended to support other services that today operate using physical addresses such as email addresses, website addresses, phone number and Geographical Positioning Systems (GPS) addresses/locations or other personal information such as a personal photograph.

An implementation, described herein, may include a system and/or a method that provide a service to register, issue and use an alias in place of a physical, PO Box address or other contact information for the goal of delivering mail, locating physical addresses, or using the contact information by another user or a service provider. These services may include but not limited to the United States Postal Services (USPS), other delivery services such as FedEx or UPS, GPS Systems, businesses that correspond with their customers, and other marketers that are trying to reach prospects through mail or other communication mediums.

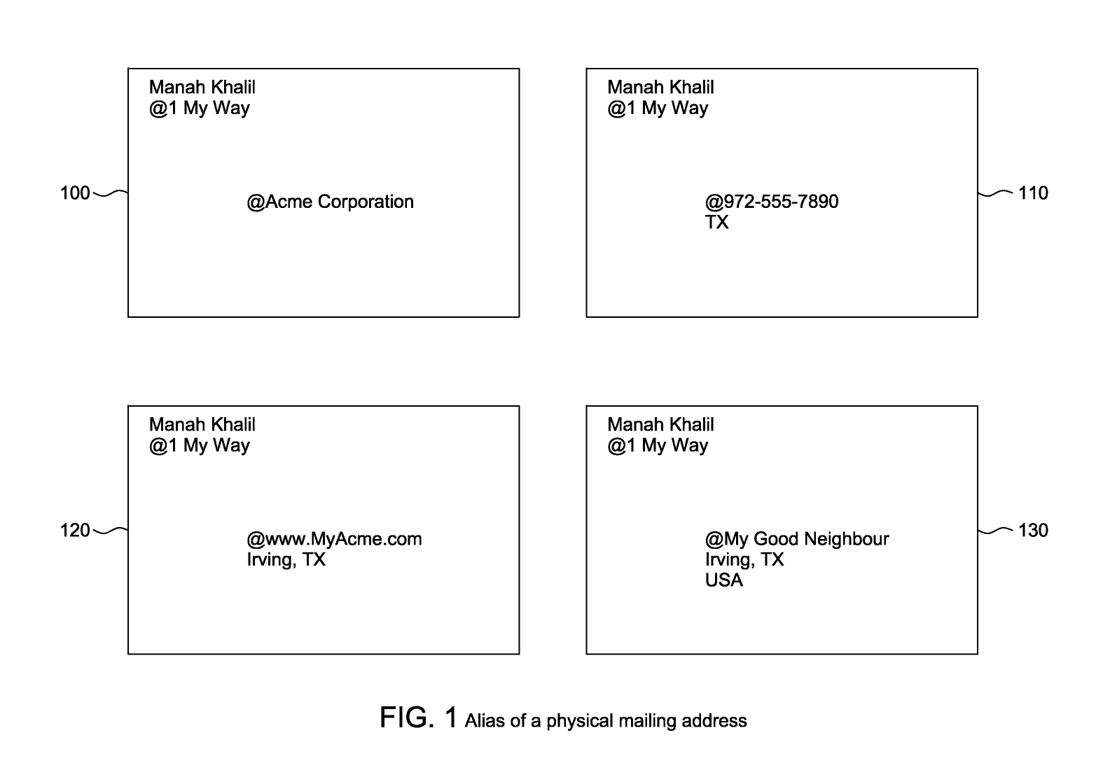

An added advantage of the described system of the present invention may allow users of the system in certain cases to infer/translate the alias to the addresses of the people or business they would need to correspond with in a similar way to how people use internet addresses today. For first example 100 in FIG. 1, the registered alias for the mailing address of Acme Corporation in the Irving, Tex. would simply be: “@Acme Corporation”. The user “Manah Khalil” can be mailing letters to Acme Corporation without the need to know the actual mailing address of that company or having to be concerned of any changes to that mailing address. In this example a delivery service would need to have translate or resolve the alias “@Acme Corporation” to the actual mailing address to complete the delivery of the letter. In a similar fashion, should the access of the delivery service to the Acme Corporation alias be denied, the alias information can be changed so that the current address does not appear for that delivery service. The owner of an alias controls and manages who has access to retrieve any part of the contact information set associated with that alias. A second example 110 in FIG. 1 illustrates an alias of a phone number “@972-555-7890” in TX to access the address. The third example 120 in FIG. 1 illustrates an alias of a website “@www.MyAcome.com” in Irving Tex., and a third example 130 in FIG. 1 illustrates an alias of “@My Good Neighbor” in Irving Tex. USA. Additionally, the special character @ or another character may be used to denote the use of an alias.

FIG. 1 illustrates that different addresses can be provided for different aliases.

FIG. 1 demonstrates customers of the new system referencing their own addresses or the address of the destination entity on mail parcels. It also lists some examples aliases for the same physical address.

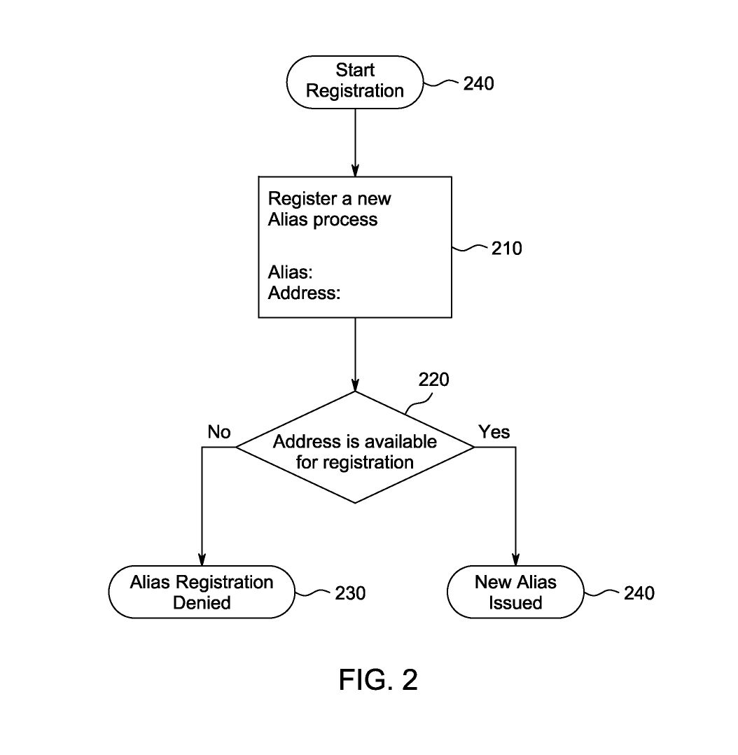

FIG. 2 describes the overall process, including the interaction with USPS, its customers, and the businesses that may interact with the new system.

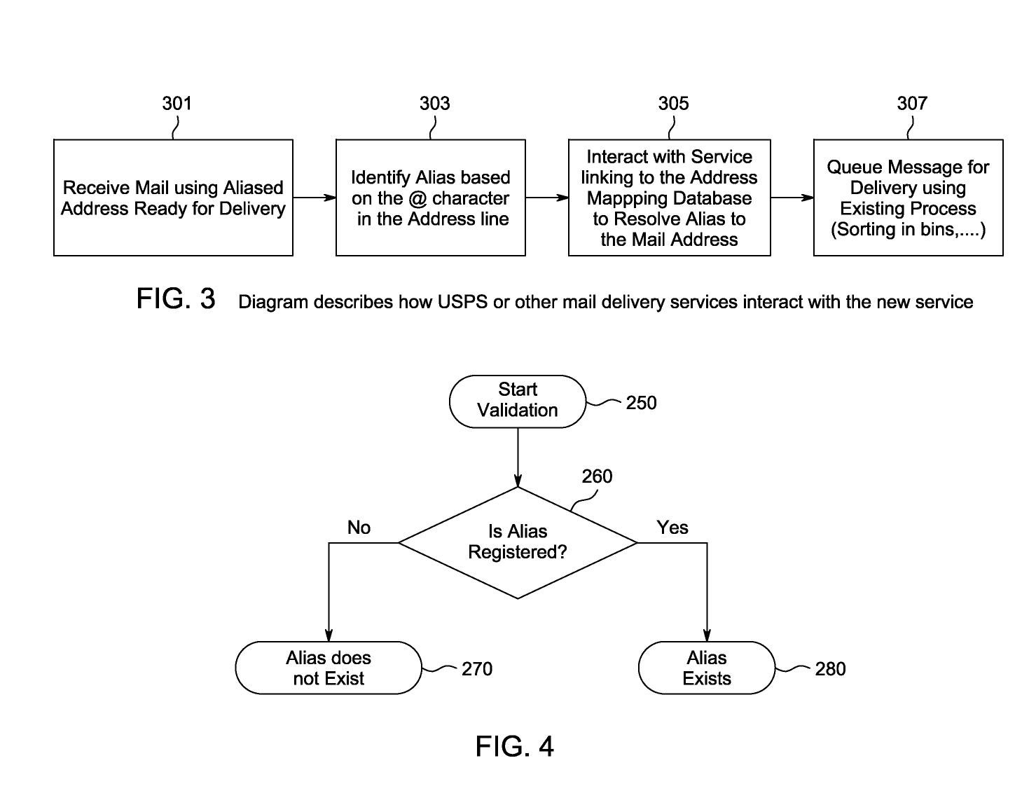

FIG. 3 describes how USPS or other mail delivery services can adopt to interact with the new system to resolve an aliased address prior to delivery.

As shown in FIG. 1. the mailing address alias will be used by business and people to exchange mail or communicate using other forms of contact information. The alias may be notations through the @ (at) character or other special characters that precedes it. The format may be therefore described as @ <alias>, where alias can be an set of alphanumeric characters or other special characters such as hyphen (-), period (.), comma (,), ampersand (&), number sign (#), space character ( ) or any other special character with the exception of the character that is used at the beginning of the alias, such as @ character in this case.

Also shown in FIG. 1. is the scope of the address can either be global, not requiring a city, state or country, or can be scoped to a country, state within a country, or city within a state and country. The scope of the alias would be inferred based on the presence or absence thereof of these additional scope locators. The format that describes the city, state or country follows the currently established format for postal services addresses.

Single physical mailing addresses can have one or more aliases. This allows the use of aliases by multiple occupants or users of the same physical address. See FIG. 1.

The service may be implemented as a database 601 as illustrated in FIG. 6 that holds the mapping between Aliases to Mailing Addresses or other contact information. The owner may access the database 601 by a computer 603 which may communicate with the database 601 through a server 605 to provide Internet access, and the user may access the database 601 by a computer 609 which may communicate with the database 601 through a server 607 to provide Internet access. The database 601 may be managed and operated to ensure new Alias registration requests are processed and granted when the Alias has not been issued before. Furthermore, the database 601 may be managed to change addresses in accordance with the need of the user. The service providers that would try to mail out correspondence to users of the Alias registry may have to validate that such Alias are still valid at the actual time of the mailing to reduce the number of times the mail be undeliverable.

Access to the Alias registry may be granted based on the established operating model which may or may not include a fee which can be defined per transaction or on a subscription basis. Registration of new Aliases may or may not incur a registration and maintenance fee. Mapping of the Aliases to mailing addresses require connection to the registry by trusted service operators to avoid access to the registry by spammers and ensure the privacy and confidentiality of the registry content and Alias owners. See FIG. 2.

The mapping database 601 that resolve the Aliases into the actual mailing address or the other contact information uses algorithms to provide close matches and can help identify if new Alias registration requests are close to existing one to help deny the registration that would result in ambiguity.

The mapping database 601 that resolve the Aliases into the actual mailing address or the other contact information uses privacy settings to provide selective access to requesting party to all or part of the contact information associated with an alias. That access is based on the identity of requesting party which has to be established in the database using existing forms of authentication such as a unique user account name and a password.

FIG. 2 illustrates that the registration process is started in step 240, in step 210, a new address is registered by entering the alias and the address. In step 220, it is determined if the address is available for registration, and if the address is not available for registration, then the alias registration is denied in step 230. If the address is available for registration, then in step 240, a new alias is issued. In FIG. 4, validation is started in step 250, and in step 260, it is determined if the alias is registered. If the alias has not been registered, the user is notified that the alias does not exist in step 270, and in step 280 if the alias is registered, the alias exits as being valid.

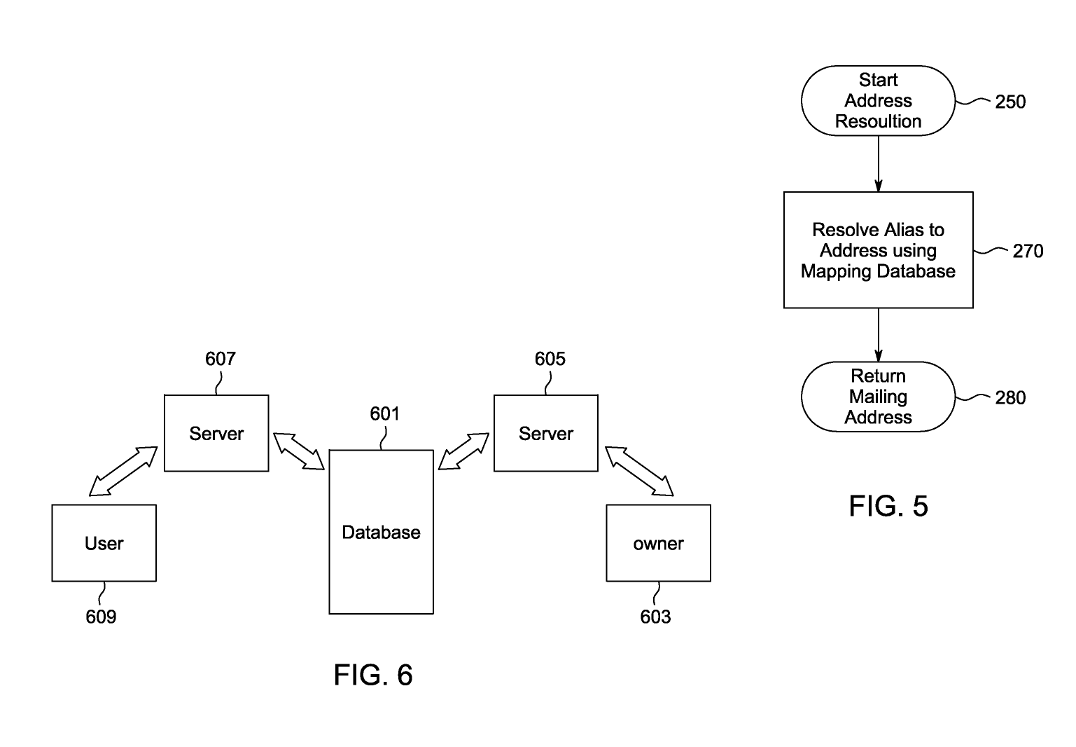

In FIG. 5, after step 280, the address resolution begins in step 250, in step 270 the database 601 is accessed by the computer 609 of the user through the server 607 and the mailing address is returned from the database 601 to the computer 609 of the user provided that the requesting user has the required permission to access the requested contact information of the alias.

The process to map back or resolve the Alias to a mailing address can be embedded in the existing standard procedure today for sorting and routing mail for delivery. An additional step would be required to perform the mapping prior to sorting or delivery of the mail. In addition this service can be used to retrieve the up to date contact information for corresponding with the owner of an alias, such as the email address.

This service maybe used by service providers that require actual physical addresses of businesses or people to check for service qualification (for example utilities or insurance companies), by providing a mapping between the alias and the physical address.

As an additional extension, the service can be linked to a process to validate the ownership of a user of an alias to the contact information linked to that alias. For instance to guarantee that a mailing address associated with an alias is truly owned by the owner of the alias, and to ensure in the future that such Aliased addresses can be used by services or business that require validated addresses, such as the Department of Motor Vehicle (DMV) for use on the Driving Licenses (DL). This can be established using procedures similar to issuing Secure Socket Layer Certificates (SSL) for secure web sites which would require in some instances some form of documentation as a proof of occupancy of aliased addresses or by mailing a letter with a confirmation code which can be used later to confirm with the aliasing service that that mail was received at the specified mailing address by the alias owner

FIG. 3 illustrates how the United States Postal Service or other mail delivery services may interact with the present invention. In step 301, mail is received using the address obtained from the database 601 for delivery, and in step 303 the alias is identified based upon the @character and in step 305, the teachings of the present invention is used to link to the address mapping database 601 to resolve the mail address. In step 307, the mail is queued for delivery by using the delivery process such as sorting in bins etc.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A method for determining an address or other contact information, comprising the steps of:
registering an alias and mapping to it one or more sets of contact information which includes an address or other contact information;
providing an alias to obtain the address or other contact information;
determining if the alias has been registered;
resolving the alias to obtain the address or other contact information.

2) A method for determining an address or other contact information as in claim 1, wherein the step of resolving the alias to obtain the address or other contact information includes the step of accessing a database.

3) A method for determining an address or other contact information as in claim 1, wherein the method includes the step of returning the mailing address or other contact information to the user.

4) A method for determining an address or other contact information as in claim 1, wherein the method includes the step of informing the user that the alias does not exist if the alias has not been registered.

5) A method for determining an address or other contact information as in claim 1, wherein the method includes the step of authenticating the user to determine eligibility to access the contact information associated with an alias.
